(19) United States
(12) Patent Application Publication
(10) Pub. No.: US 2006/0294116 A1
(43) Pub. Date: Dec. 28, 2006

(54) Search system that returns query results as files in a file system

(76) Inventor: Michael Cameron Hay, Mountain View, CA (US)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 11/166,063

(22) Filed: Jun. 23, 2005

(51) Int. Cl. G06F 7/00

(52) U.S. Cl. 707/100

(57) ABSTRACT

Search systems that perform a search or inquiry to find information elements that satisfy some searching criteria usually return some indication of these information elements in a form that can be viewed or accessed only within the search system itself. An improved system presents the information elements as files in a conventional file system so that the search results can be viewed or accessed by essentially any program or other facility that is capable of accessing conventional files.

### TECHNICAL FIELD

The present invention is related generally to methods and devices such as computers for processing data and is related more particularly to methods and devices that may be used to process and present information representing the results of an inquiry or search for data that satisfies one or more search criteria.

### Background Art

Typical search systems receive one or more search criteria from an individual, perform a search or inquiry to find information elements that satisfy the criteria, and return the search results to the individual as some special purpose presentation of the information elements that were found by the search. These typical search systems are often implemented by computer programs that provide the environment or user interface through which search criteria are received and through which search results are presented. This type of implementation makes it difficult to access and manipulate search results by anything other than the search system itself or by other programs that have been developed for this purpose.

Those who work on complex projects often create and store information elements such as letters, electronic mail messages, drawings, data files, database records, reports and other types of documents, and they access these information elements in the course of their work. Typical search systems allow a user to find or identify information elements that satisfy one or more search criteria but some indication of the identified information elements is presented only through programs that either implement the search system itself or that implement special purpose applications developed specifically for this purpose. Specially developed programs usually cannot be developed quickly and they are often expensive to implement but they are necessary when the search system does not provide the type of access to search results that is needed. There is no known way to access the search results using general purpose programs such as word processors or file manager utilities.

### DISCLOSURE OF INVENTION

It is an object of the present invention to allow access to search results obtained by essentially any search system to be accessed by programs that are capable of accessing files in a file system. This object is achieved by the present invention as claimed.

According to one aspect, the present invention generates a structure of information elements representing search results of an inquiry based on one or more search criteria. Each information element represents an information entity having data content stored on computer-accessible storage and having one or more characteristics that satisfy the one or more search criteria. At least one information element represents an information entity that is not a file in a file system that comprises a plurality of files referenced by entries in a hierarchical structure of directories. Requests are received from a program to access files in the file system and examined to determine which requests are directed toward actual files in the file system and which are directed toward pseudo-files corresponding to entities represented by information elements in the structure of information of elements. Requests directed toward actual files in the file system are processed by invoking one or more processes in a first set of processes. Requests directed toward pseudo-files are processed by invoking one or more processes in a second set of processes that simulate operations performed by processes in the first set of processes such that pseudo-files are accessible to the program as actual files.

The various features of the present invention and its preferred embodiments may be better understood by referring to the following discussion and the accompanying drawings in which like reference numerals refer to like elements in the several figures. The contents of the following discussion and the drawings are set forth as examples only and should not be understood to represent limitations upon the scope of the present invention.

### BRIEF DESCRIPTION OF DRAWINGS

FIG. 1 is a schematic block diagram of a computer system incorporating a processing unit, a storage controller, and storage.

FIG. 2 is a schematic block diagram of a computer system showing one implementation of the storage controller.

FIG. 3 is a schematic block diagram of a computer system that implements various aspects of the present invention in the processing unit.

FIG. 4 is a schematic block diagram of a computer system that implements various aspects of the present invention in the storage controller.

### MODES FOR CARRYING OUT THE INVENTION

### A. Overview

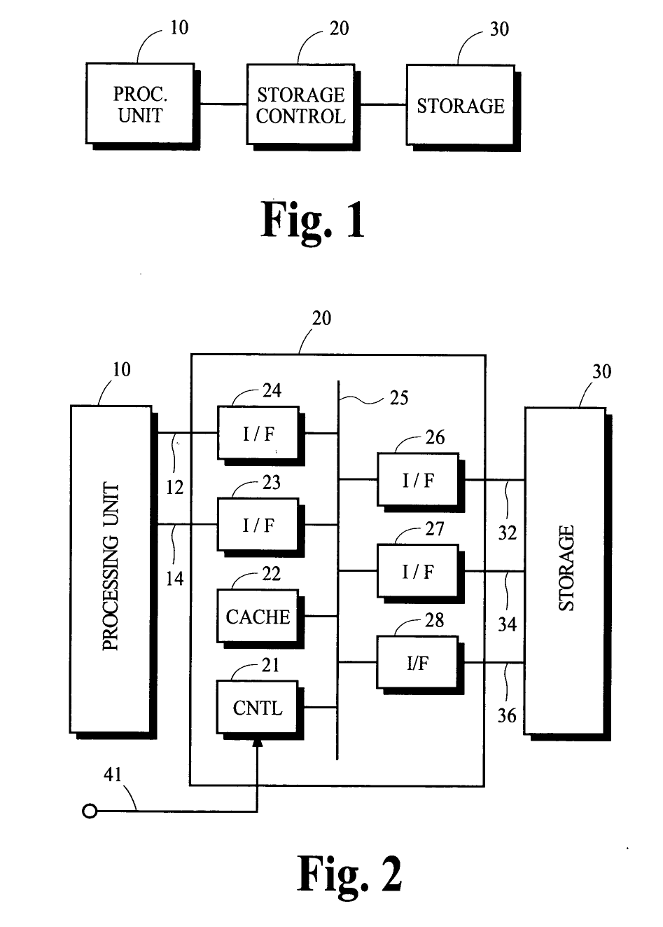

FIG. 1 illustrates major components in a computer system that may incorporate various aspects of the present invention as explained below. The system includes a processing unit 10 and an information storage subsystem including a storage controller 20 and storage 30. Each of these components may be implemented in a wide variety of ways.

The processing unit 10 represents the main system components of an information processing machine including mainframe computers, mini-computers and micro-computers. Examples of mainframe computers include the Skyline series of Hitachi Data Systems, Inc., Santa Clara, Calif., described in “Skyline Series Functional Characteristic,” document number FE-95G9010, which is incorporated herein by reference. An example of a personal computer includes the main system board incorporating one or more microprocessors or one or more microcomputers available from Intel Corporation, Santa Clara, Calif., from Advanced Micro Devices, Inc., Sunnyvale, Calif., and Apple Computer, Inc., Cupertino, Calif. Various components such as memory, processors, input and output devices, and interface circuitry are not shown for the sake of illustrative simplicity. These components are not shown or discussed further because these details are not needed to explain the present invention.

Storage 30 represents one or more devices that store information to and retrieve information from some recording medium such as magnetic or optical disks. It is anticipated that the present invention will be used with various types of storage equipment using random-access storage media like rotating disks; however, the principles of the present invention may be applied to other types of equipment including storage equipment with media such as cards, tape and circuitry that record information using a wide variety of technologies including magnetic, optical and solid-state technologies.

The storage controller 20 includes components that control the operation of storage 30 and control the flow of information between the processing unit 10 and storage 30. For example, in response to a read command from the processing unit 10, the storage controller 20 causes storage 30 to retrieve the requested information from its recording media and to send that information to the processing unit 10. In response to a write command from the processing unit 10, the storage controller 20 causes storage 30 to record the specified information using its recording media.

The storage controller 20 and storage 30 may be implemented as discrete or separate equipment or they may be integrated in a manner that makes separation difficult if not impossible. The schematic diagram in FIG. 2 illustrates one implementation of separate equipment in which various components of the storage controller 20 are coupled to bus 25. The components 23, 24 provide electrical interfaces for the data communication paths 12, 14 to exchange information with the processing unit 10, and the components 26, 27, 28 provide electrical interfaces for the data communication paths 32, 34, 36 to exchange information with storage 30. The cache 22 provides cache memory that may be used to improve the speed of operations that cause information to flow between the processing unit 10 and storage 30. The control 21 includes one or more processors that perform operations needed to implement storage controller functions. The bus 25 may be one bus or it may comprise signal paths that are arranged in multiple buses. Other components related to features such as power, timing, memory or diagnostics are omitted for illustrative clarity.

These storage controller 20 and storage 30 may operate according to essentially any standard including those used by mainframe computers, mid-size or mini-computers, and personal or micro-computers. A few examples include the standards used by the 9200 and 9900 Series of storage equipment manufactured by Hitachi, Ltd., Tokyo, Japan, the Symmetrix line of storage equipment manufactured by EMC Corporation, Hopkinton, Mass., System 390 compatible storage equipment manufactured by International Business Machines Corporation, Armonk, N.Y., and the Small Computer System Interface (SCSI) and Integrated Drive Electronics (IDE) standards used with many micro-processor based computer systems. No particular standard or operating protocol is critical to the present invention.

The operations required to implement various aspects of the present invention can be performed by components of the processing unit 10 or the storage controller 20. These components may be implemented in a wide variety of ways including integrated circuits, one or more ASICs, and/or processors that execute programs of instructions recorded by optical, magnetic or solid state media. The manner in which these components are implemented is not important to the present invention. Implementations of the present invention that are embodied in programs may be conveyed by a variety of machine readable media such as baseband or modulated communication paths throughout the spectrum including from supersonic to ultraviolet frequencies, or recording media that convey information using essentially any recording technology including magnetic tape, cards or disk, optical cards or disc, and detectable markings on media including paper.

### B. Processing Unit

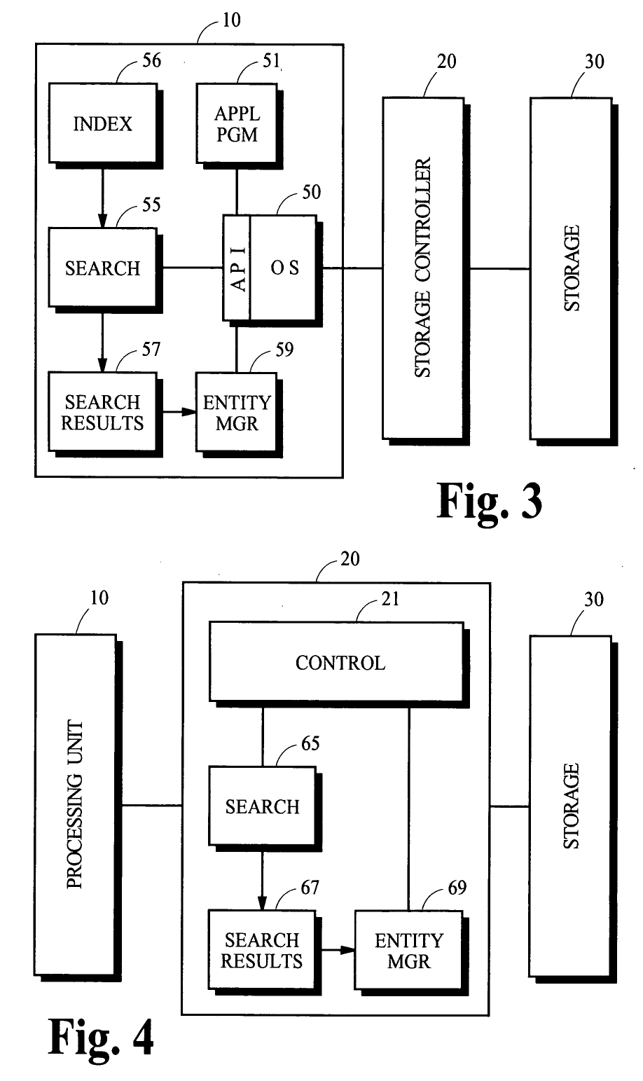

FIG. 3 is a schematic illustration of one way in which the present invention may be implemented by operations performed by the processing unit 10. In this implementation, the processing unit 10 executes one or more programs that implement an operating system 50, an application program 51, a searching facility 55 and an information entity manager 59.

The searching facility 55 receives one or more search criteria from an operator interface or from some other source, searches for “information entities” having characteristics that satisfy the one or more search criteria, and records a representation of the search results 57 in the form of “information elements” that identify those information entities that satisfy the search criteria. The characteristics may be based on data content of the entity, or may be based on associated information such as entity creation date, entity size or name of the entity content author. For example, the searching facility 55 may be a utility that examines the textual content of electronic mail (email) messages or data base records stored in proprietary or special-purpose formats to identify which of those messages or records have content that satisfies the one or more search criteria. Each of the messages and records is an information entity and the search results are represented by information elements that refer to or identify which of those messages or records satisfy the search criteria. The searching facility 55 may use an index 56 to reduce the time needed to perform the search. The information elements in the search results 57 may be recorded in memory that is accessible by the processing unit 10 or they may be recorded by a recording medium such as a recording medium in storage 30.

Either or both of the index 56 and the search results 57 may be updated automatically as information entities are changed. This may be done by one or more programs that monitor these changes. Alternatively, either or both of the index 56 and the search results 57 may remain unchanged as the entities are changed and subsequently updated by processes that are performed when desired.

Each information entity that satisfies the search criteria may be accessed as if it is a file in a conventional file system regardless how the entity itself is stored. A program 51 such as a browser, file manager, text editor or word processor may access the information entities represented in the search results by invoking conventional file access operations such as open and read commands. Requests to invoke these commands use the information elements in place of conventional parameters that specify files within a plurality of files referenced by entries in a hierarchical structure of directories of a conventional file system. Examples of such file systems are implemented by a variety of operating systems including MS/DOS, Unix, Linux, MacOS and all versions of Windows. Requests to access the entities as files are directed to facilities that perform appropriate operations with the actual entities and return results that simulate the results that would have been obtained had the entities been actual files. This may be done as shown in FIG. 3 by examining each request submitted to the input/output (I/O) application programming interface (API) of an operating system 50 to determine if the request is directed toward an actual file or toward a pseudo-file specified by an information element in the search results 57. If the request is directed toward an actual file, the request is processed normally. If the request is directed toward a pseudo-file, the information entity manager 59 processes the request by using the information element and the search results 57 to identify the actual information entity and then invokes the appropriate program logic to access the entity. If the entity is an email message or data base record, for example, the information entity manager 59 invokes a program that is able to access the proprietary or special-purpose format in which the email message or data base record is stored. The information entity manager 59 may submit conventional I/O requests to the I/O API of the operating system 50 to access the actual entities.

An exemplary implementation of some aspects of the present invention is shown in an Appendix to this disclosure. The example is represented by source code written in an Open Source Initiative (OSI) certified open-source programming language known as Python. Additional information about this programming language may be obtained from the internet site http://www.python.org. Neither the choice of programming language nor the particular architecture of the example are critical to the present invention.

### C. Storage Controller

FIG. 4 is a schematic illustration of one way in which the present invention may be implemented by operations performed by the storage controller 20. In this implementation, the control 21 in the storage controller 20 may execute one or more programs that implement a searching facility 65 and an information entity manager 69, or it may control other components that implement the searching facility 65 and the information entity manager 69.

The searching facility 65 receives one or more search criteria either from a program executing in the processing unit 10 or from input received through control line 41 as shown in FIG. 2, searches for information entities that satisfy the one or more search criteria, and records a representation of the search results 67 in the form of information elements either in memory or on a recording medium in the storage controller 20, or on a recording medium in storage 30. For example, the searching facility 65 may be a utility that examines email messages or data base records stored in proprietary or special-purpose formats as described above. The searching facility 65 may use an index. As explained above, either or both of the index and the search results 67 may be updated automatically as information entities are changed, or either or both of the index and the search results 67 may remain unchanged as the entities are changed and subsequently updated by processes that are performed when desired.

Each information entity that satisfies the search result may be accessed as if it is a file in a conventional file system regardless how the entity itself is stored. A program such as a browser, file manager, text editor or word processor that is executed by the processing unit 10 may access the information entities represented in the search results by invoking conventional file access operations such as open and read commands. Requests to invoke the commands use the information elements in place of conventional parameters that specify files within a plurality of files that are referenced by entries in a hierarchical structure of directories of a conventional file system. Requests to access the entities as files are directed to facilities within the storage controller 20 that perform appropriate operations with the actual entities and return results that simulate the results that would have been obtained had the entities been actual files. This may be done as shown in FIG. 4 by examining file-related commands received from the processing unit 10 to determine if a command is directed toward an actual file or toward a pseudo-file that is specified by an information element in the search results 67. If the request is directed toward an actual file, the command is processed normally. If the request is directed toward a pseudo-file, the information entity manager 69 uses the search results 67 while processing the command to identify the actual information entity and then invokes the appropriate program logic to access the entity. If the entity is an email message or data base record, for example, the information entity manager 69 invokes a program that is able to access the proprietary or special-purpose format in which the email message or data base record is stored.

### D. Variations

If desired, the operations needed to implement various aspects of the present invention may be performed by processes distributed between the processing unit 10 and the storage controller 20. In addition, the various components described above may be distributed among multiple processing units or among multiple storage controllers that are interconnected by a network or by point-to-point communication paths.

APPENDIX The following source code is written in the open
source programming language “Python” and may be used
to implement various aspects of the present invention.

#!/usr/bin/env python
import os, clibase, sys, thread, re, string
import os.path as pth
from pprint import pprint
from errno import *
from stat import *
from fuse import Fuse, ErrnoWrapper
from string import join
from pprint import pprint
tag_string=re.compile(r‘\hat{ }\S*\:|\$$’)
_version_tag_=tag_string.sub(“,“$id$”)
_version_= re.sub (r‘\S*v\s|\,.*$’, ”, _version_tag_)
_author_tag_=“$author$”
_author_=tag_string.sub (“,_author_tag_)
_date_tag_=“$date$”
_date_=tag_string.sub (”,_date_tag_)
_copyright_=“Copyright (c) 2005 Hitachi Data Systems, Inc. All rights reserved.”
class SearchFs (Fuse):

def _init_(self, searchString, mountPoint, inputFile=None,

fsOptions=None, winShare=None):

self.search_string=searchString
self.input_file=inputFile
self.file_list={}
self._getSearchResults ( )
self.mountpoint=self._getMountPoint (mountPoint)
self.optlist=[]
self.optdict={}
if fsOptions:

my_options=fsOptions
options=my_options.split(“,”)
for option in options:

try:

key, value = option.split (“=”, 1)
self.optdict[key] = value

except:

self.optlist.append (option)

def _getSearchResults (self):

p=os.popen (“beagle-query \”“ + self.search_string + \

“\” |grep ‘file://’”)

s=re.compile (r‘\hat{ }file\:’)
for line in p.read ( ).split (“\n”):

if not s.match (line): continue
fq_file=‘/’ + string.lstrip (line, ‘file:/’)
self.file_list[pth.basename (fq_file)]={

‘path’: pth.dirname (fq_file),
‘full_path’: fq_file}

p.close

def _getResultsFromFile (self):

blank=re.compile (r‘\hat{ }\s*$’)
fl=open (‘./InputFs.files’)
for line in fl.read ( ).split (“\n”):

if blank.match (line): continue
self.file_list[pth.basename (line)]={

‘path’: pth.dirname (line),
‘full_path’: line}

fl.close

def _getMountPoint (self, mountPoint):

print mountPoint
try: os.stat (str (mountPoint))
except OSError:

try: os.makedirs (str (mountPoint))
except OSError:

return −1

return mountPoint

def _lookupFile (self, path):

if path == 7“: return path

else: return (self.file_list[pth.basename (path)][‘full_path’])

def getattr(self, path):

return os.lstat (self._lookupFile (path))

def readlink(self, path):

return os.readlink(self._lookupFile (path))

def getdir(self, path):

#if path == “/”: return −1
#Add files and special directories to our special directory
f_list=[]
for obj in “.”, “..”:

f_list.append (obj)

for obj in self.file_list.keys ( ):

f_list.append (obj)

return map(lambda x: (x,0), f_list)

def unlink(self, path):

return −1

def rmdir(self, path):

return −1

def symlink(self, path, path1):

return −1

def rename(self, path, path1):

return −1

def link(self, path, path1):

return −1

def chmod(self, path, mode):

return −1

def chown(self, path, user, group):

return −1

def truncate(self, path, size):

return −1

def mknod(self, path, mode, dev):

return −1

def mkdir(self, path, mode):

return −1

def utime(self, path, times):

return −1

def open(self, path, flags):

os.close (os.open(self._lookupFile (path), flags))
return 0

def read(self, path, len, offset):

f = open (self._lookupFile (path), “r”)
f.seek (offset)
return f.read(len)

def write(self, path, buf, off):

return −1

def release(self, path, flags):

return −1

def statfs(self):

“““
Should return a tuple with the following 6 elements:

- blocksize - size of file blocks, in bytes
- totalblocks - total number of blocks in the filesystem
- freeblocks - number of free blocks
- totalfiles - total number of file inodes
- freefiles - nunber of free file inodes

Feel free to set any of the above values to 0, which tells
the kernel that the info is not available.
“““
print “xmp.py:Xmp:statfs: returning fictitious values”
blocks_size = 1024
blocks = 100000
blocks free = 25000
files = 100000
files_free = 60000
namelen = 80
return (blocks_size, blocks, blocks_free, files, files_free, namelen)

def fsync(self, path, isfsyncfile):

return −1

def main (self):

Fuse.main (self)

if _name_== ‘_main_’:

my_cli=clibase.clibase ( )
my_parser=my_cli.rootCliOpts ( )
my_parser.add_option (“-s”, “--search”,

dest=“search”, action=“store”, type=“string”,
metavar=“SEARCH”, help=“The search string”)

my_parser.add_option (“-m”, “--basemount”,

dest=“mount”, action=“store”, type=“string”,
metavar=“MOUNT”, help=“Optional mountpoint for filesystem”)

my_parser.add_option (“-w”, “--winshare”,

dest=“share”, action=“store”, type=“string”,
metavar=“SHARE”, help=“Define an optional Windows share”)

(opts, args)=my_parser.parse_args ( )
if not opts.search: sys.exit (1) #need to print an error/usage here
my_mount=os.environ[‘HOME’] + ‘/Desktop’ + ‘/Searches’ + \

‘/’ + opts.search

server=SearchFs (opts.search, my_mount)
server.multithreaded = 1;
server.main( )

1. A method performed by a device, wherein the method comprises:
generating a structure of information elements representing search results of an inquiry based on one or more search criteria, wherein each information element represents an entity having data content stored on computer-accessible storage and having one or more characteristics that satisfy the one or more search criteria, and wherein at least one information element represents an entity that is not a file in a file system that comprises a plurality of files referenced by entries in a hierarchical structure of directories;
receiving requests from a program to access files in the file system and determining which requests are directed toward actual files in the file system and which requests are directed toward pseudo-files corresponding to entities represented by information elements in the structure of information of elements;
processing requests directed toward actual files in the file system by invoking one or more processes in a first set of processes; and
processing requests directed toward pseudo-files by invoking one or more processes in a second set of processes that simulate operations performed by processes in the first set of processes such that pseudo-files are accessible to the program as actual files.

2. The method according to claim 1, wherein at least some of the information elements are stored as respective files in the file system.

3. The method according to claim 1, wherein at least some of the information elements are not stored as files in the file system but comprise data processed by components of the device such that each information element is presented to the program as a file in the file system.

4. The method according to claim 1, wherein the device is coupled to an information storage subsystem comprising one or more storage devices that operate under control of a storage controller, the search results are stored by the information storage subsystem, and the information elements are obtained by the storage controller.

5. The method according to claim 4, wherein the inquiry is performed by components in the storage controller.

6. The method according to claim 1, wherein the program is executed by another device that is coupled to the device by a network connection and the requests to the components of the operating system are received through the network connection.

7. The method according to claim 1 wherein at least some of the information elements represent search results of an inquiry performed by the device and at least some of the information elements represent search results of an inquiry performed by another device.

8. The method according to claim 1 that comprises:
receiving inquiry parameters that specify the one or more search criteria, selecting those entities having one or more characteristics that satisfy the one or more search criteria, and generating the information elements such that a respective information element represents a respective selected entity; and
generating references that correspond to the information elements, a respective reference presented as a file in the file system and providing a link to its corresponding selected entity such that the data content of the selected entity may be accessed as data content of a file in the filesystem.

9. A device for processing information that comprises:
memory; and
one or more processors coupled to the memory that are adapted to perform a method comprising:
generating a structure of information elements representing search results of an inquiry based on one or more search criteria, wherein each information element represents an entity having data content stored on computer-accessible storage and having one or more characteristics that satisfy the one or more search criteria, and wherein at least one information element represents an entity that is not a file in a file system that comprises a plurality of files referenced by entries in a hierarchical structure of directories;
receiving requests from a program to access files in the file system and determining which requests are directed toward actual files in the file system and which requests are directed toward pseudo-files corresponding to entities represented by information elements in the structure of information of elements;
processing requests directed toward actual files in the file system by invoking one or more processes in a first set of processes; and
processing requests directed toward pseudo-files by invoking one or more processes in a second set of processes that simulate operations performed by processes in the first set of processes such that pseudo-files are accessible to the program as actual files.

10. The device according to claim 9, wherein at least some of the information elements are stored as respective files in the file system.

11. The device according to claim 9, wherein at least some of the information elements are not stored as files in the file system but comprise data processed by components of the device such that each information element is presented to the program as a file in the file system.

12. The device according to claim 9 that is coupled to an information storage subsystem comprising one or more storage devices that operate under control of a storage controller, the search results are stored by the information storage subsystem, and the information elements are obtained by the storage controller.

13. The device according to claim 12, wherein the inquiry is performed by components in the storage controller.

14. The device according to claim 9, wherein the program is executed by another device that is coupled to the device by a network connection and the requests to the components of the operating system are received through the network connection.

15. The device according to claim 9 wherein at least some of the information elements represent search results of an inquiry performed by the device and at least some of the information elements represent search results of an inquiry performed by another device.

16. The device according to claim 9, wherein the method comprises:
receiving inquiry parameters that specify the one or more search criteria, selecting those entities having one or more characteristics that satisfy the one or more search criteria, and generating the information elements such that a respective information element represents a respective selected entity; and
generating references that correspond to the information elements, a respective reference presented as a file in the file system and providing a link to its corresponding selected entity such that the data content of the selected entity may be accessed as data content of a file in the filesystem.

17. A medium conveying a program of instructions that is executable by a device to perform a method that comprises:
generating a structure of information elements representing search results of an inquiry based on one or more search criteria, wherein each information element represents an entity having data content stored on computer-accessible storage and having one or more characteristics that satisfy the one or more search criteria, and wherein at least one information element represents an entity that is not a file in a file system that comprises a plurality of files referenced by entries in a hierarchical structure of directories;
receiving requests from a program to access files in the file system and determining which requests are directed toward actual files in the file system and which requests are directed toward pseudo-files corresponding to entities represented by information elements in the structure of information of elements;
processing requests directed toward actual files in the file system by invoking one or more processes in a first set of processes; and
processing requests directed toward pseudo-files by invoking one or more processes in a second set of processes that simulate operations performed by processes in the first set of processes such that pseudo-files are accessible to the program as actual files.

18. The medium according to claim 17, wherein at least some of the information elements are stored as respective files in the file system.

19. The medium according to claim 17, wherein at least some of the information elements are not stored as files in the file system but comprise data processed by components of the device such that each information element is presented to the program as a file in the file system.

20. The medium according to claim 17, wherein the device is coupled to an information storage subsystem comprising one or more storage devices that operate under control of a storage controller, the search results are stored by the information storage subsystem, and the information elements are obtained by the storage controller.

21. The medium according to claim 20, wherein the inquiry is performed by components in the storage controller.

22. The medium according to claim 17, wherein the program is executed by another device that is coupled to the device by a network connection and the requests to the components of the operating system are received through the network connection.

23. The medium according to claim 17 wherein at least some of the information elements represent search results of an inquiry performed by the device and at least some of the information elements represent search results of an inquiry performed by another device.

24. The medium according to claim 17, wherein the method comprises:
receiving inquiry parameters that specify the one or more search criteria, selecting those entities having one or more characteristics that satisfy the one or more search criteria, and generating the information elements such that a respective information element represents a respective selected entity; and
generating references that correspond to the information elements, a respective reference presented as a file in the file system and providing a link to its corresponding selected entity such that the data content of the selected entity may be accessed as data content of a file in the filesystem.
